(19) United States
(12) Patent Application Publication
(10) Pub. No.: US 2003/0097334 A1
(43) Pub. Date: May 22, 2003

(54) Information processing system, information processing method, program and recording medium

(75) Inventors: Shinichi Obata, Fujisawa (JP); Akio Shinagawa, Ibaraki (JP)

Correspondence Address: McDermott, Will & Emery, 600, 13th Street, N.W., Washington, DC, 20005-3096, US

(73) Assignee: Hitachi, Ltd.

(21) Appl. No.: 10/214,575

(22) Filed: Aug. 9, 2002

(30) Foreign Application Priority Data
Nov. 16, 2001 (JP) 2001-351115

(51) Int. Cl. G06F 17/60

(52) U.S. Cl. 705/51; 705/57

(57) ABSTRACT

An information processing system such as a portable telephone or PC is provided in which operating convenience for displaying the notification of copyright protection information is improved. The system includes an interface for receiving first information regarding a video and/or a audio and second information for restricting a processing of the first information, a memory for storing the first and second information received by the interface, and a processor for processing the video and/or the audio based on the first information stored in the memory and displaying information for restricting the processing of the first information based on the stored second information while the video and/or the audio based on the first information is being processed.

### FIELD OF THE INVENTION

The present invention relates to an information processing system such as a portable phone terminal, PDA (Personal Digital Assistant) or PC (Personal Computer), an information distribution method and apparatus such as a server for transmitting data to the information processing system, an information distribution system, a program provided to the information processing system, etc., and a recording medium for recording the program.

### BACKGROUND OF THE INVENTION

A method of displaying contents with information added thereto is described in, for example, JP-A-2001-142786, in which the additional information such as the information for protecting copyright is displayed in detail in response to an instruction of the user. Also, an icon of a contents file is displayed in a different form according to the presence or absence of information protected by copyright.

### SUMMARY OF THE INVENTION

In the method as described in JP-A-2001-142786, however, the additional information for restricting the processing of the contents such as how many more times playback or duplication is possible cannot be indicated to the user. The user, who wants to know whether there is any restriction of processing the contents or whether the playback of the contents is possible again or not, for example, has to take the trouble of inputting an instruction for displaying the additional information. Also, the additional information, if displayed before reproducing the contents, may be overlooked or forgot. Further, the user is not satisfied if a notice such as “THIS IS THE LAST PRODUCTION SESSION AVAILABLE” is displayed after the contents have been completely reproduced.

Accordingly, in view of the problems of the prior art described above, an object of the present invention is to improve the operating convenience of display or provide an easy-to-use display for copyright protection.

In order to achieve the object described above, according to one aspect of the invention, there is provided an information processing system comprising means for receiving first information for video and/or audio data and second information for restricting the processing of the first information, storage means for storing the first and second information received by the receiving means, means for processing the video and/or audio data based on the first information stored in the storage means, and control means for controlling so as to display information for restricting the processing of the first information based on the second information during the processing of the video and/or audio data based on the first information.

As a result, the additional information for restricting the playback and/or duplication can be notified even during the playback of the contents. Thus, the user can sensorially recognize the additional information without switching the screen by giving an instruction to display particular additional information, thereby improving the usability.

According to another aspect of the invention, there is provided an information output method for receiving a request signal from an information processing system, for example, and outputting content information corresponding to the request signal, wherein the content information is output together with control information for restricting the use of the content information and position information for indicating the position at which the control information is displayed on a display screen of the information processing system.

As a result, the load on an information processing terminal can be reduced for sensorially recognizing process control information for restricting the process of playback and/or duplication.

Other objects, features and advantages of the invention will become apparent from the following description of the embodiments of the invention taken in conjunction with the accompanying drawings.

### BRIEF DESCRIPTION OF THE DRAWINGS

FIG. 1 is a flowchart showing an example of a method of displaying a content with copyright protection information according to this invention.

FIGS. 2A to 2C show examples of the format of contents with the copyright protection information assumed to be used according to an embodiment of the invention.

FIG. 3 is an illustration showing an example of the display screen in the method of displaying contents with the copyright protection information according to this invention.

FIG. 4 is a flowchart showing another example of the method of displaying a content with copyright protection information divided into three categories according to this invention.

FIG. 5 is an illustration showing an example of the display screen in which the specifics of the copyright protection information are divided into three categories according to an embodiment of the invention.

FIGS. 6A and 6B are illustrations showing examples of the display screen with different color display areas set according to an embodiment of the invention.

FIGS. 7A and 7B are illustrations showing examples of the display screen with upper and lower band display areas set for color display according to an embodiment of the invention.

FIG. 8 is an illustration showing examples of the display screen with upper and lower band display areas set for color display according to the invention.

FIG. 9 shows an example of the manner in which the screen is displayed in a portable communication terminal according to this invention.

FIG. 10 is a block diagram showing a portable communication terminal for realizing a method of displaying contents with the copyright protection information according to an embodiment of this invention.

FIG. 11 is an illustration showing an example of the display screen with upper and lower display areas set for color display according to an embodiment of the invention.

FIG. 12 is a flowchart showing an example of a method of displaying contents with the copyright protection information divided into three categories including the non-display according to another embodiment of this invention.

FIG. 13 is an illustration showing an example of the display screen divided into three categories including the non-display in a method of displaying contents with the copyright protection information according to still another embodiment of this invention.

FIG. 14 is a flowchart showing an example of a method of displaying contents with the copyright protection information divided into three categories according to a further embodiment of this invention.

FIG. 15 is an illustration showing an example of the display screen divided into three categories in a method of displaying the contents with the copyright protection information according to this invention.

FIG. 16 is a flowchart showing a pattern of the display area in a method of displaying the contents with the copyright protection information according to this invention.

FIG. 17 is an illustration showing a display screen having a pattern of the display area in a method of displaying the contents with the copyright protection information according to this invention.

FIG. 18 is an illustration showing a display screen having a pattern of the display area at a designated position in a method of displaying the contents with the copyright protection information according to an embodiment of this invention.

FIG. 19 is a table showing an example of the display color set for playback of the contents corresponding to the copyright protection information.

FIG. 20 is a table showing an example of the display color set for playback of the contents corresponding to the copyright protection information.

FIG. 21 is a flowchart for processing the video and audio data according to an embodiment of the invention.

FIGS. 22A and 22B are illustrations showing an example of the display screen for processing the audio data according to this invention.

FIGS. 23A and 23B are illustrations showing another example of the display screen for processing the audio data according to this invention.

FIG. 24 is a block diagram showing a configuration of an apparatus for realizing an information processing method according to an embodiment of the invention.

FIG. 25 is a flowchart for explaining an information processing method according to an embodiment of the invention.

FIG. 26 is an illustration showing a general configuration of a system according to an embodiment of the invention.

FIG. 27 shows a data format according to an embodiment of the invention.

FIGS. 28A and 28B are illustrations showing an example of a screen set by the user according to this invention.

FIG. 29 is an illustration showing a display screen for improving the usability according to an embodiment of the invention.

FIG. 30 is an illustration showing a screen used for the contents folder or the like according to an embodiment of the invention.

### DETAILED DESCRIPTION OF THE EMBODIMENTS

Embodiments of the present invention will be explained below with reference to the accompanying drawings. In the embodiments described below, the additional information is considered as but not limited to the information for protecting the copyright (hereinafter referred to as “the copyright protection information”).

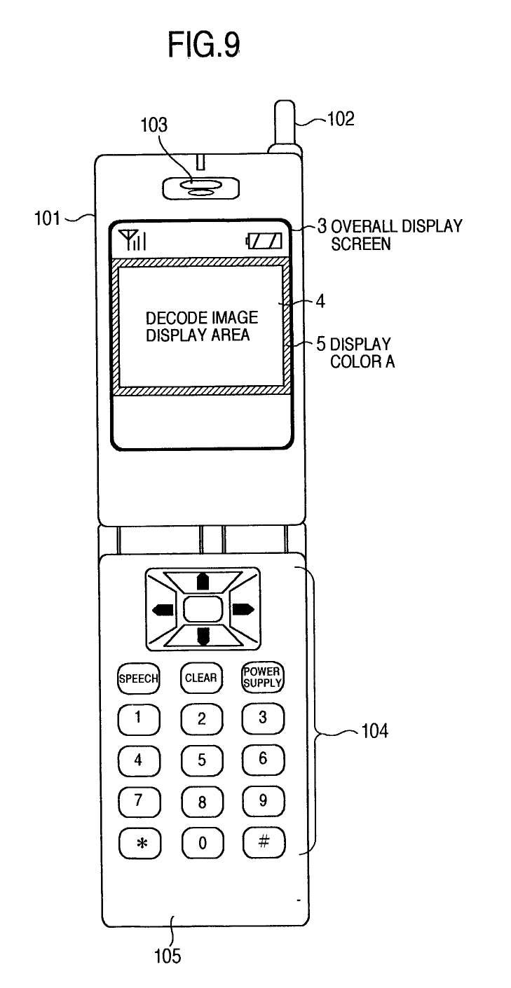

FIG. 9 shows an video of an actual application of the invention to a portable telephone. A portable telephone is configured of a body 101, an antenna 102, a speaker 103, an operating key panel 104, a microphone 105 and a display screen 3. A decode image display area 4 is set in the display screen 3, and a display area 5 is arranged outside the decode image display area 4. During the playback of a content in the decode image display area 4, the display color of a display area 5 of a frame shape changes in accordance with the conditions for and the specifics of restriction of the processing such as the playback and/or duplication included in the copyright protection information added to the content.

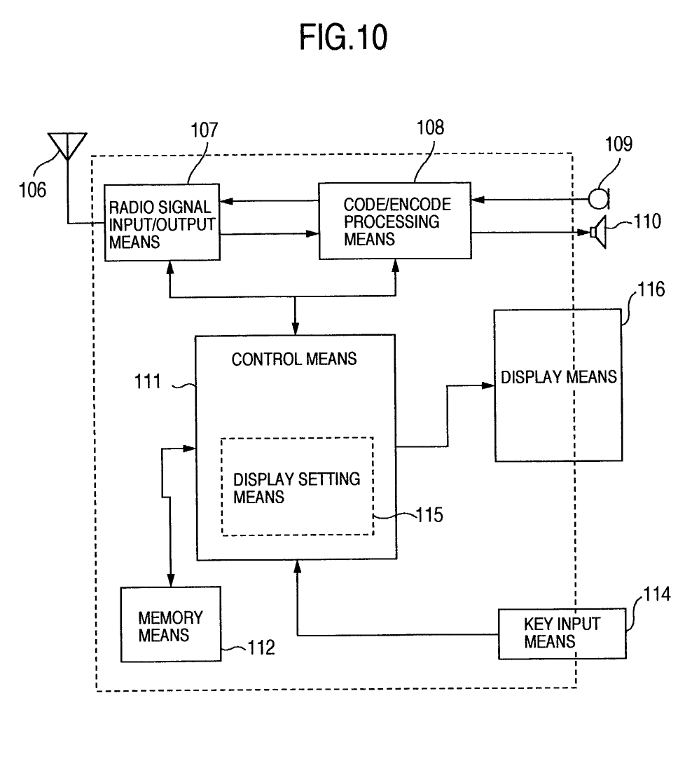

FIG. 10 shows an example of the hardware configuration of a portable communication terminal embodying the invention. The portable communication terminal comprises an antenna 106 for transmitting/receiving a radio wave, radio signal input/output means 107 for controlling the process of receiving the received radio signal from the antenna 106 and the process of transmitting a transmission radio signal to the antenna 106, code/decode processing means 108 for decoding the signal from the radio signal input/output means 107 and outputting it as an audio signal on the one hand and encoding an input audio signal and sending a decoded audio signal to the radio signal input/output means 107 on the other hand, a microphone 109 for receiving and outputting a audio to the code/decode processing means 108, a speaker 110 for outputting a audio from the audio signal output of the code/decode processing means 108, control means 111 for controlling the whole process collectively on the one hand and the receiving and reproduction (playback) of the content on the other hand, storage means 112 for holding content data, copyright information and history data including the number of times and the period during which the content is reproduced or duplicated, key input means 114 for receiving a key operation from the user, and display means 116 for displaying an video.

The control means 111, upon receipt of an instruction for playback or duplication of the content from the key input means 114, reads the copyright protection information attached to a designated content stored in the storage means 112. When the specifics of the copyright protection information limit a processing such as playback or duplication of the content, a first display color is selected, and otherwise a second display color is selected. The control means 111 controls the playback or duplication of the content, and displays a reproduced image of the content on the display means 116. Further, when displaying the reproduced content image on the display means 116, an area outside the display area thereof is filled up with the first or second display color selected as described above.

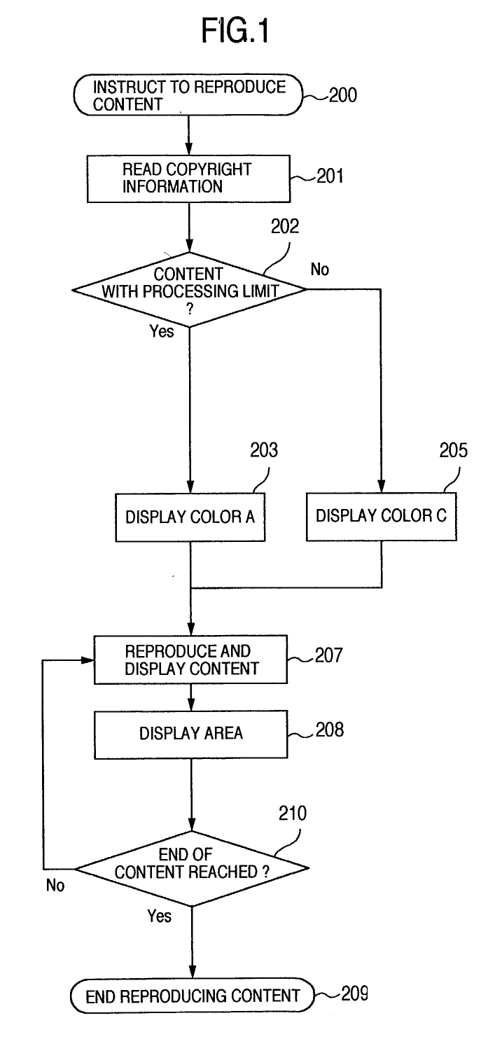

FIG. 1 is a flowchart showing an example process flow of a method for displaying a content at a portable communication terminal. The process is started with a content playback instruction step (200), followed by a copyright protection information read step (201) for reading the copyright protection information such as the limitation of the processing of playback or duplication. In a processing restriction determining step (202), it is determined whether the specifics of the copyright protection information indicates the processing limitation or not. When the determination in the processing restriction determining step (202) indicates that the content is free from the processing limitation, the display area is set to color C in a display color setting step (205). When the determination in the processing restriction determining step (202) indicates that the content processing is limited, in contrast, the display area is set to color A in a display color setting step (203). In a content display step (207), the content is displayed. Further, in an area display step (208), the area outside the content display area is displayed in a color designated in the display color setting step (205) or the display color setting step (203).

In this way, the user is not required to take the trouble of giving an instruction to display the copyright protection information or switching to a screen capable of displaying the copyright protection information. Thus, the user can be sensorially informed of the general property of the content by the display color during the playback thereof without adversely affecting the quality of the content display.

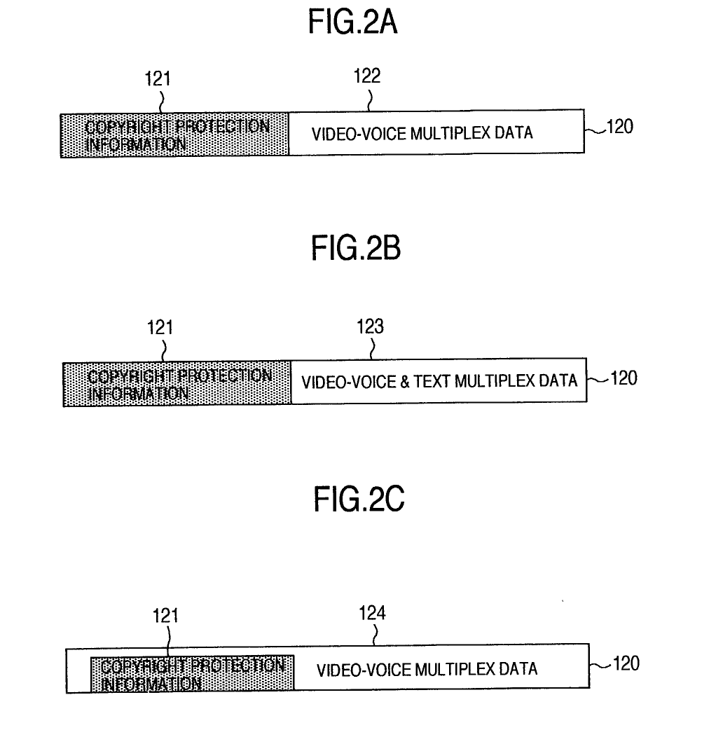

FIGS. 2A to 2C show examples of the data structure of the content with the copyright protection information handled in the content display method at the portable communication terminal. FIG. 2A shows a content 120 with copyright protection information 121 attached to a video/sound multiplex data 122. When determining the display color in the example of FIG. 1, the copyright protection information 121 is read and analyzed. Another example of content is a data 123 including a text data in addition to video/sound multiplex data as shown in FIG. 2B or a video/sound multiplex data 124 incorporating the copyright protection information 121 as shown in FIG. 2C. In any case, when determining the display color, the copyright protection information 121 is read and the specifics thereof analyzed, so that the display area with the content under playback can be displayed in a display color corresponding to the specifics of the copyright protection information.

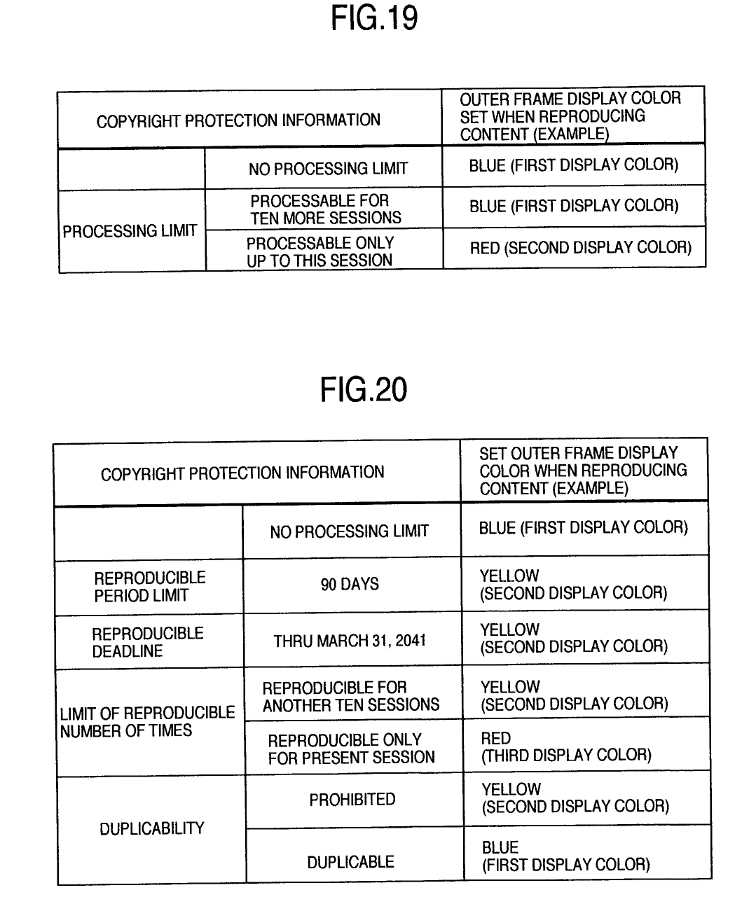

FIG. 19 shows an example of setting a display color corresponding to the specifics of the copyright protection information during the content playback. In this case, the first display color is set as blue for “NO PROCESSING LIMITATION” or “PROCESSING POSSIBLE ALSO FOR NEXT SESSION”, while the second display color is defined as red only for “PROCESSING POSSIBLE ONLY FOR PRESENT SESSION”. This color classification can sensorially provide information in simplistic fashion, during each session of content playback, as to whether the processing of content can be continued or is possible only for the present session.

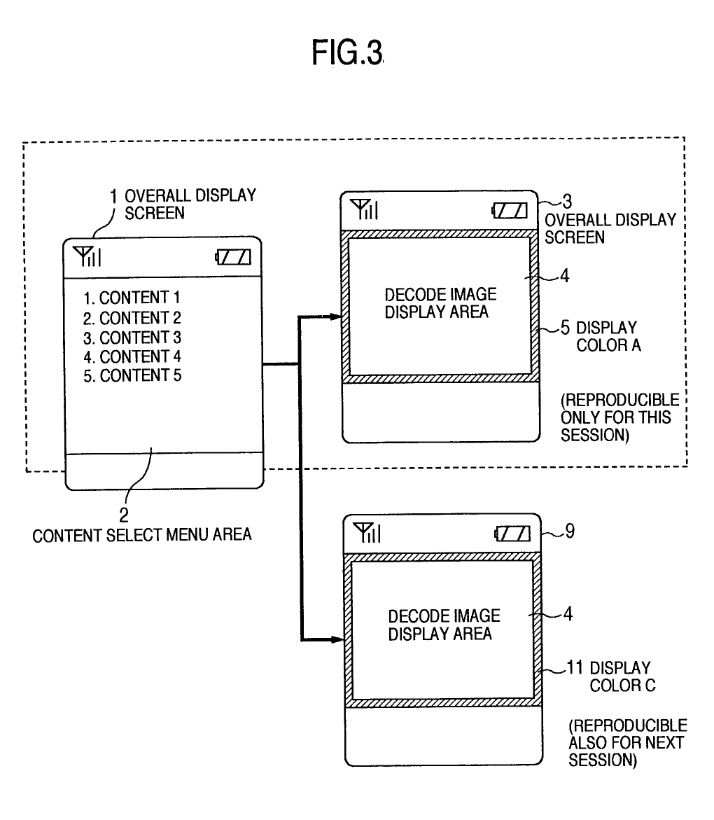

FIG. 3 shows the screen displaying the result of the processing in the example of FIG. 1. Each content is displayed in an overall display screen 1 which includes a content select menu area 2. As a result of giving a playback instruction for one content, the content is reproduced and displayed with a different display color in accordance with the specifics of the copyright protection information attached to the content. When the specifics of the copyright protection information can be reproduced only for the present session, the area 5 is displayed in color A like the overall display screen 3, so that the content is reproduced and displayed in the decode image display area 4. When the specifics of the copyright protection information indicate that the content can be reproduced without restriction, on the other hand, an area 11 is displayed in color C as shown in an overall display screen 9, so that the content is reproduced and displayed in the decode image display area 4. According to this embodiment, in order to maintain the quality of the content, the copyright protection information is displayed in the area outside the content. Nevertheless, the copyright protection information can be displayed inside the content to the extent that the display of the content is not affected.

Using this mechanism, a different display color is displayed according to the specifics of the copyright protection information during content playback. Thus, the user can be sensorially informed of the copyright protection information of the content without taking the trouble of switching the display screen. Also, the user can be warned against the copyright when reproducing a content accompanying the copyright protection information, and therefore enlightened on the importance of copyright protection.

The period during which a content is being processed can be defined as a period during which the content is actually reproduced or duplicated, or a period between a time point when an instruction is given to reproduce or duplicate the content and a time point when the playback or duplication, as the case may be, is ended automatically or in accordance with an instruction. The copyright protection information can be notified by displaying it constantly, at regular intervals or at any timing during the period when the content is processed.

In view of this, control means may be provided to notify the copyright protection information during a time lag which may be inserted between the time when a content playback instruction is given and the actual time of starting the content reproduction or content playback. By so doing, the copyright protection information of the content, of which the processing instruction has been given, may be automatically notified conveniently to the user immediately before actual playback of the content.

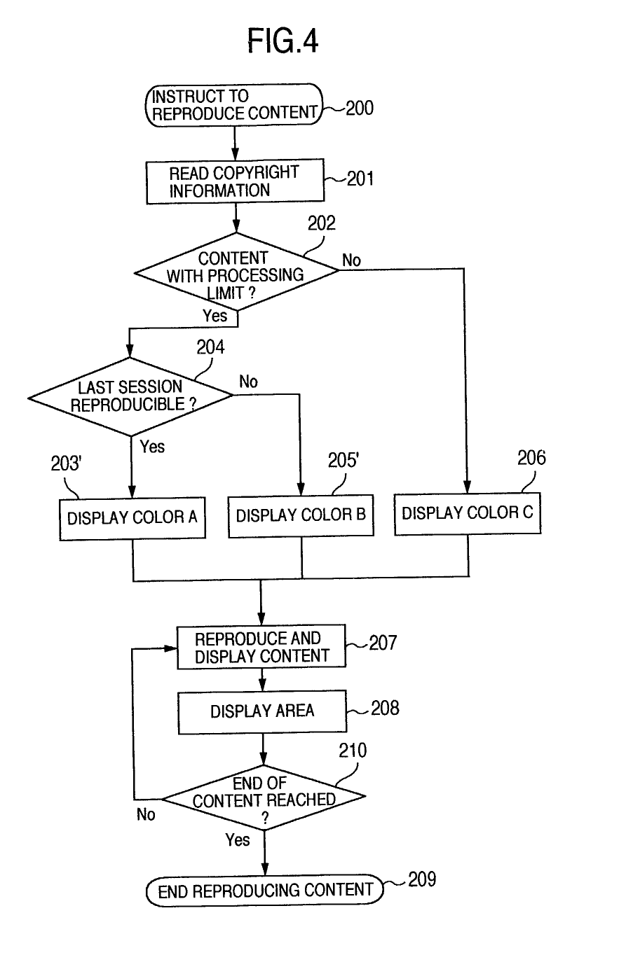

FIG. 4 shows a processing according to a second embodiment of the present invention in which the specifics of the copyright protection information attached to the content of the example shown in FIG. 1 is classified and processed in three categories. The process up to the processing limitation determining step (202) is similar to the corresponding process shown in FIG. 1.

When it is determined in the processing limitation determining step (202) that the content is accompanied by the processing limitation, the number of processing sessions and the time of the processing hitherto required for playback or duplication are counted to determine in a processing determining step (204) whether the content can be processed only for the present session or not. When the content can be processed only for the present session, the display color A is set for the display area in a display color setting step (203′). When the content can be processed also for the next session, on the other hand, the display color B is set for the display area in a display color setting step (205′). When it is determined that the content is free from the processing limitation in the processing limitation determining step (202), the display color C is set for the display area in a display color setting step (206). Then, the content is displayed in the content display step (207). Further, in the area display step (208), the area considered outside the content display area is displayed in a display color designated in the display color setting step (206), the display color setting step (205′) or the display color setting step (203′).

FIG. 20 shows an example in which the display colors corresponding to the specifics of the copyright protection information are set at the time of reproducing the contents. In this case, though not limited, the first display color of blue is set for “PROCESSING NOT LIMITED” or “DUPLICABLE”, the second display color of yellow is set for “PROCESSING LIMITED BUT PRESENT SESSION IS NOT LAST REPRODUCIBLE ONE”, and the third display color of red is set for “REPRODUCIBLE ONLY FOR PRESENT SESSION”.

A specific example of the processing limitation includes a plurality of categories. For example, the remaining reproducible period is limited to “90 DAYS”, the playback possible “THRU Mar. 31, 2041”, the playback possible only for “10 MORE SESSIONS” or “ONE MORE SESSION”, and the duplication is “PROHIBITED”. For the content which is free from playback limitation and can be reproduced for an indefinite period of time, in contrast, the first display color of blue is assigned. For the content of which the processing limit, though set, is not yet reached, on the other hand, the second display color of yellow is assigned to draw the attention of the user. Further, for the content of which playback is possible only up to the present session, the third display color of red is assigned indicating that the particular content will soon become out of use. Although the above-mentioned embodiments use no different display colors to distinguish between the remaining number of reproducible sessions and the remaining reproducible period, the display color can of course be varied between a case involving the number of remaining reproducible sessions and a case involving the remaining reproducible period, in accordance with the category of the processing limitation. By doing so, it can be easily known whether the information limiting the processing of the content is related with the remaining number of available playback sessions or the remaining reproducible period.

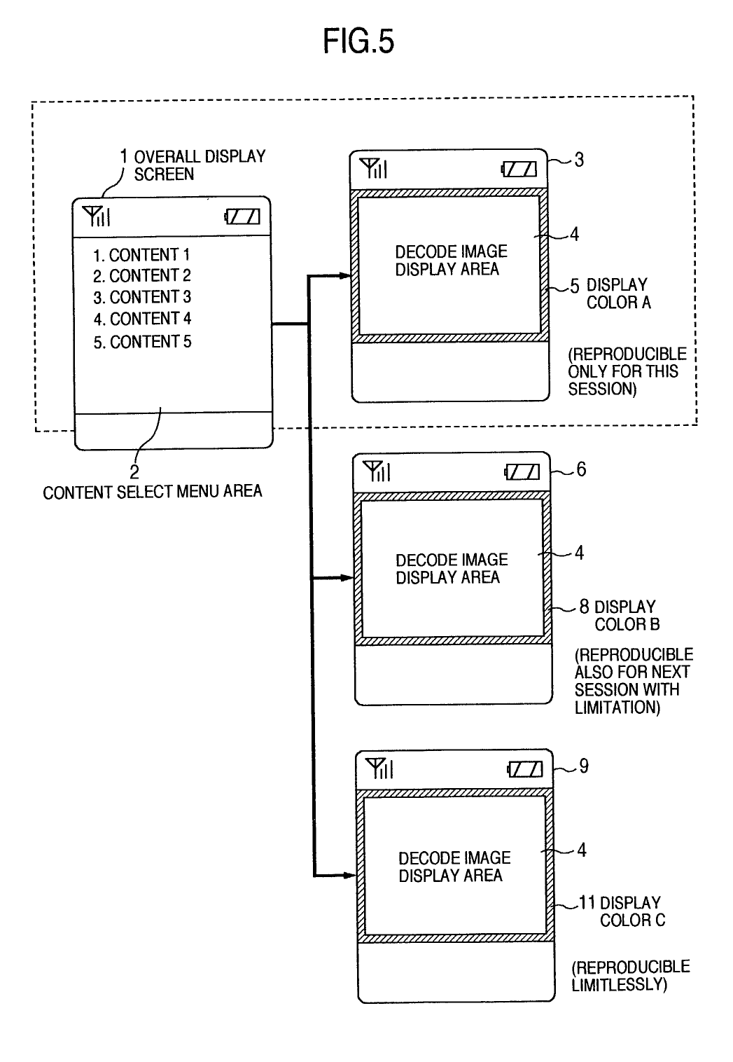

FIG. 5 shows processing results displayed on the screen according to the second embodiment. The content select menu area 2 is located in the overall display screen 1, where contents are displayed. Upon giving an instruction to reproduce one content, the content is reproduced and displayed with a different display color in accordance with the specifics of the copyright protection information added to the particular content. When the specifics of the copyright protection information indicate that the playback is possible only for the present session, the display area 5 is displayed in color A as in the overall display screen 3, so that the content is reproduced and displayed in the decode video display area 4. When the specifics of the copyright protection information indicate that the processing is limited and the playback is possible also for the next session, on the other hand, a display area 8 is displayed in display color B as in an overall display screen 6, so that the content is reproduced and displayed in the decode video display area 4. Further, in the case where the specifics of the copyright protection information indicate that there is no processing limitation, a display area 11 is displayed in display color C as in the overall display screen 9, and the content is reproduced and displayed in the decode video display area 4.

The contents are reproduced with these display colors, thereby making it possible to give a brief announcement to the user as to the processing limitation during the playback of a given content. This permits a given content to continue to be processed each time it is reproduced, without taking the trouble of inputting an instruction on the part of the user to display the copyright protection information. At the time of content playback, therefore, the user can be briefly informed sensorially, for example, of whether the processing is possible only up to the present session. Also, the user can be warned against the copyright together with a content at the time of playback, and therefore can be enlightened on the importance of the copyright protection.

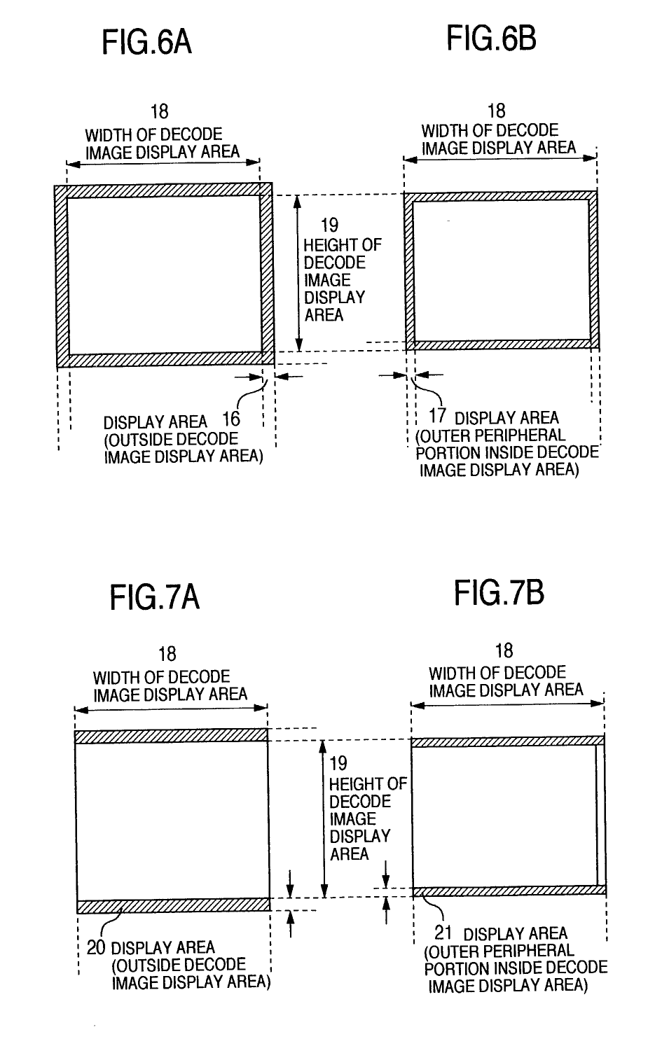

Next, a third embodiment of the present invention will be explained. Unlike in the foregoing embodiments in which the content display area is surrounded in its entirety by the display area for the display color, the outer frame for the display color area is not necessarily limited, as illustrated with reference to FIGS. 6A, 6B and 7A, 7B showing the third embodiment.

FIG. 6B shows a display area 17 constituted as a frame having a predetermined width formed inside a content display area 18. As understood from the comparison with a display area 16 surrounding the outside of the content display area 18 shown in FIG. 6A, the outermost peripheral part of the content display area 18 is filled up with the display color in FIG. 6B. Even when the size of the longitudinal or the lateral side or both the longitudinal and lateral sides of the display area of a display device is not larger than the decode display size of the content, therefore, a colored display area is made available to briefly notify the user of the copyright protection information.

FIGS. 7A and 7B show a case in which thin band areas of a predetermined color on the upper and lower side, instead of the outer frame area surrounding the exactly whole content display area, sandwich the content display area. FIG. 7A shows a process for filling up the display color in a band-shaped display areas 20 sandwiching the outside of a content display area 19. FIG. 7B, on the other hand, shows a case in which the display color is filled up in an upper and lower band-shaped internal peripheral display areas 21 of a predetermined width inside the content display area 19. In FIGS. 7A, 7B, as in the case of FIGS. 6A, 6B, therefore, a notice can be given in simplistic way of the copyright protection information.

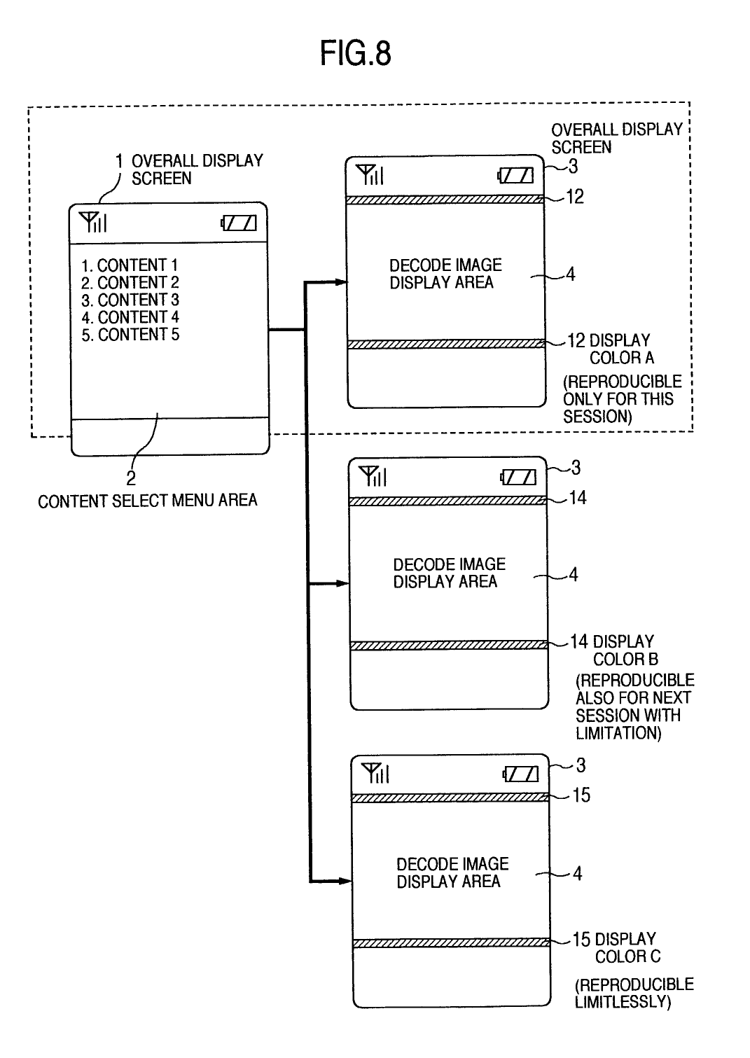

FIG. 8 shows screens displaying the result of the processing in FIG. 7A. A content select menu area 2 is located in the overall display screen 1, in which contents are displayed. Assuming that an instruction is issued to reproduce one content, the content is reproduced and displayed with a different display color in accordance with the specifics of the copyright protection information added to the content. When the specifics of the copyright protection information indicate that the playback is possible only for the present session, the display color A (say, red) is displayed in an area 12 as in the overall display screen 3, and the content is reproduced and displayed in the decode video display area 4. When the specifics of the copyright protection information indicate that the processing is limited but the playback is possible also for the next session, on the other hand, an area 14 is displayed in color B (say, yellow) as in the overall display screen 6, and the particular content is reproduced and displayed in the decode video display area 4. Further, when the specifics of the copyright protection information indicate that the limitless playback is possible, an area 15 is displayed in color C (say, blue or green) as in the overall display screen 9, and the content is reproduced and displayed in the decode video display area 4.

As a result, the user can be sensorially informed of the general property of a content simply by reproducing the particular content without any need to give an instruction to display the copyright protection information or switch to a screen capable of displaying the copyright protection information.

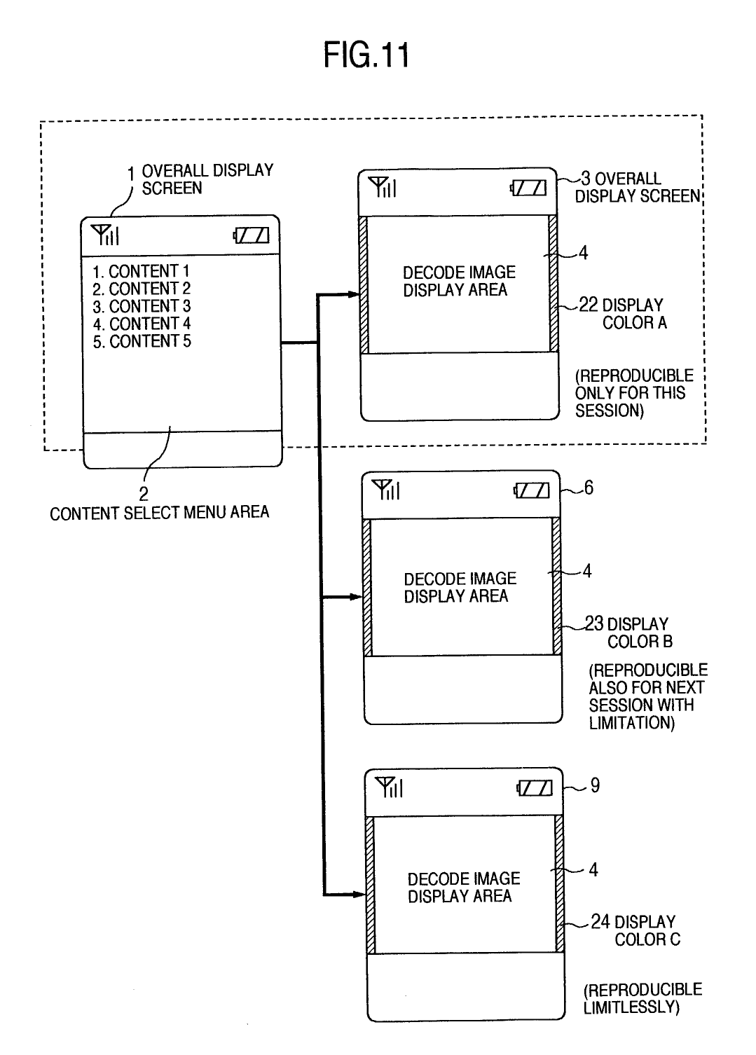

Next, a fourth embodiment of the present invention will be explained with reference to FIG. 11. This embodiment concerns a form in which the copyright information is displayed. The example shown in FIG. 11, unlike those shown in FIGS. 5 and 8, uses the band-shaped areas at the right and left ends as display areas outside the decode image display area 4. In this way, a similar effect to the examples of FIGS. 5 and 8 can be produced by displaying the right and left ends in color with a predetermined width instead of displaying the whole surrounding outer periphery of the decode video display area 4.

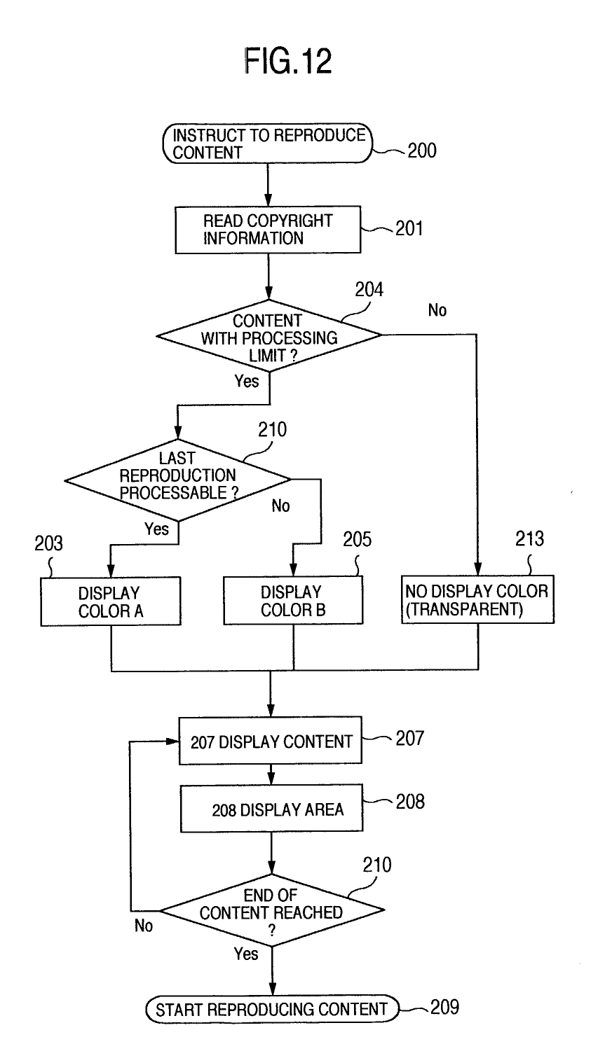

FIG. 12 shows an example in which a transparent display color is set, i.e. no color is set for the display area in a display color setting step (213) when the content is free of the processing limitation in the embodiment shown in FIG. 4. The processing steps other than the display color setting step (213) are identical to those of the embodiment shown in FIG. 4. In the display color setting step (213), the transparent color is set as a display color of the display area.

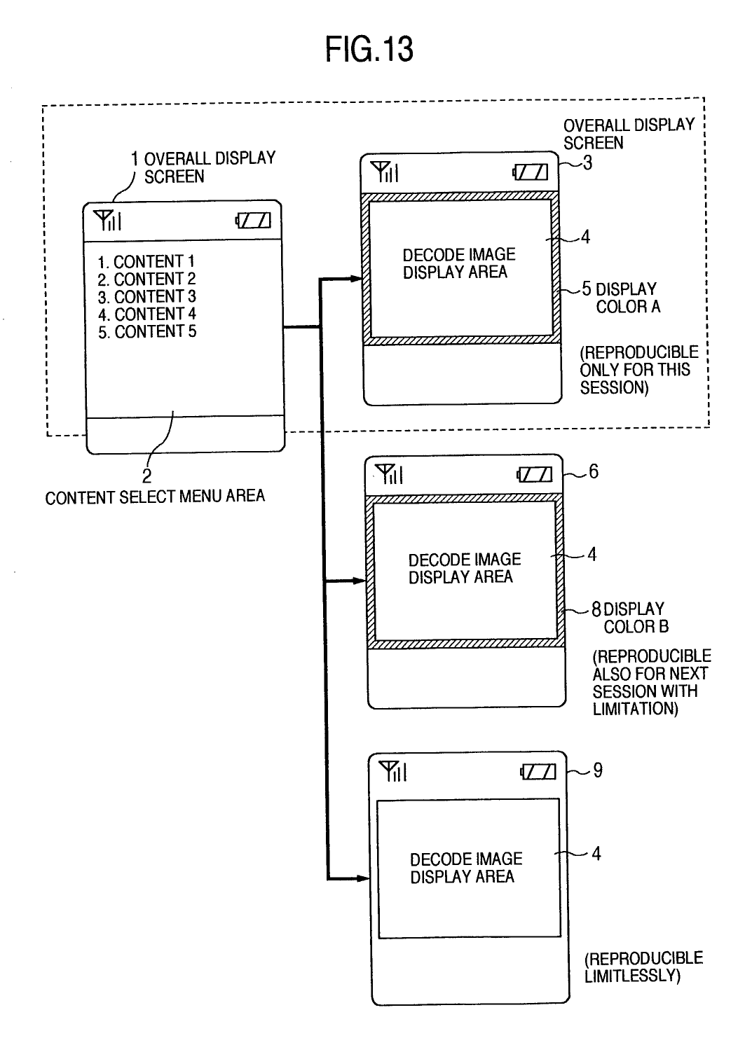

FIG. 13 shows the result of processing displayed on the screen according to the embodiment of FIG. 12. The overall display screen 9 in the embodiment of FIG. 13 is different from that of the embodiment of FIG. 5 in the same way as the embodiment of FIG. 12 is different from the embodiment of FIG. 4. Thus, the embodiment of FIG. 13 is similar to that of FIG. 5 other than the overall display screen 9. When the specifics of the copyright protection information indicate that the processing is free from limitation, the display area is displayed in transparent color as in the overall display screen 9. In short, the process is performed not to display the display area.

As a result, whether the processing is limited or not can be sensorially grasped according to whether the color information is displayed or not, without taking the trouble of switching the display during the playback of the content. Further, the display color of the display area can be used to determine whether the content can be processed only up to the present session or can be processed also in the next session.

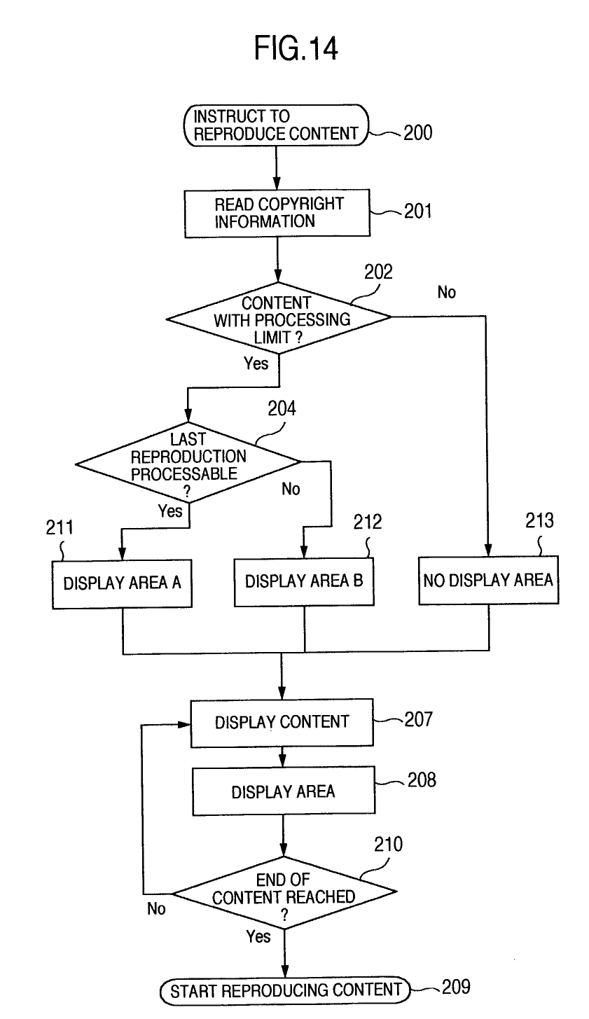

Next, a fifth embodiment of the present invention will be explained with reference to FIG. 14. FIG. 14 shows another embodiment of a contents display method in which the copyright protection information attached to the contents are processed by being classified into three categories. Specifically, the display area outside the content playback display area is set into a plurality of display areas, and the simple information corresponding to the specifics of the copyright protection information added to the contents is notified by a combination of the processes for the respective display areas. The process up to the processing limitation determining step (202) for determining whether the content is accompanied by the processing limitations for playback or duplication is similar to that of the embodiment shown in FIG. 4. When the determination in the processing limitation determining step (202) indicates that a content is accompanied by the processing limitation, the number of times or the processing time consumed up to the present playback or duplication session is counted. The process thus is transferred to the processing limit determining step (204) for determining whether the content can be processed only up to the present session. When the content can be processed only up to the present session, the processing of the display area A is set in a display area setting step (211). When the content can be processed in subsequent sessions, on the other hand, the processing in the display area B is set in a display area setting step (212).

When it is determined in the processing limitation determining step (202) that the content is free from the processing limitation, the non-use of the display areas is set in a display area setting step (213). The content is then displayed in the content display step (207). Further, in the area display step (208), the area outside the content display area is displayed in a color as designated in the display area setting step (211) or the display are setting step (212).

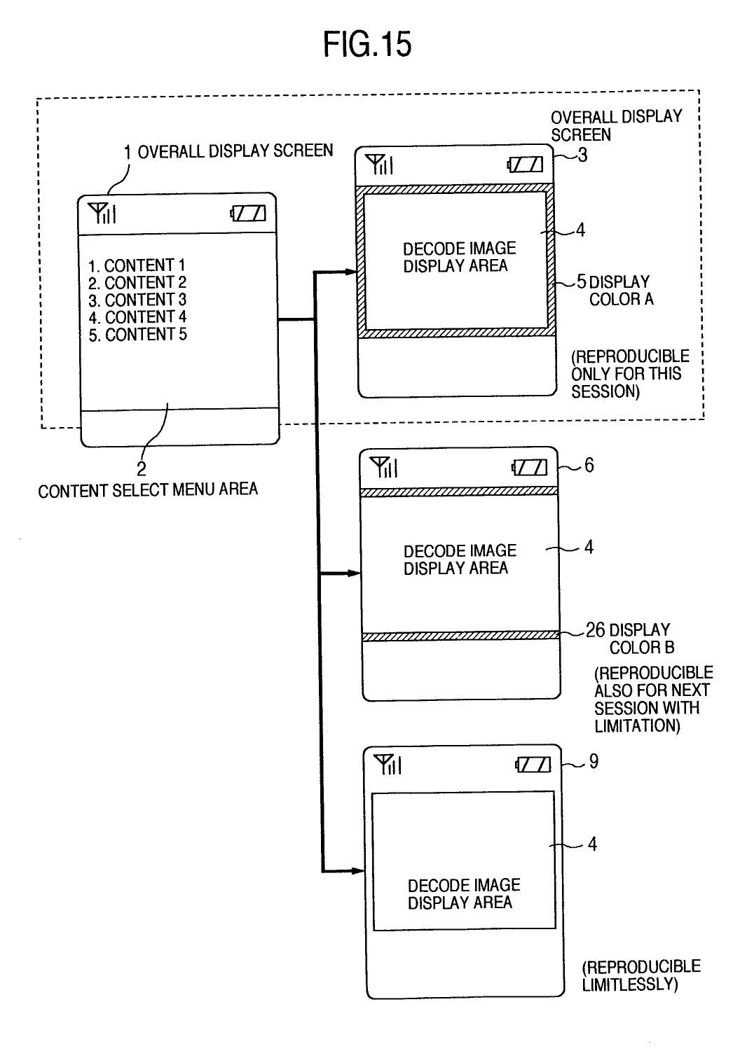

FIG. 15 shows screens displaying the results of the processing in the embodiment shown in FIG. 14. As a result of giving an instruction to reproduce one content, the content is reproduced and displayed in a different color in a different display area in accordance with the specifics of the copyright protection information attached to the content. When the specifics of the copyright protection information indicate that the playback is possible only for the present session, for example, a display area 25 surrounding the outside of the content playback display area is displayed in a color as shown in the overall display screen 3. When the specifics of the copyright protection information indicate that the processing is limited but the playback is possible also for the next session, on the other hand, band-shaped display areas 26 at the upper and lower ends are displayed in a color as in the overall display screen 6. Further, when the specifics of the copyright protection information indicate that the playback is free of limitation, no display area is used as in the overall display screen 9.

This mechanism makes it possible for the user to sensorially grasp the difference of the copyright protection information of the content according to the range of color display outside the display area where the content is reproduced. Thus the copyright protection information can be notified to the user in simplistic fashion even during the playback of the content.

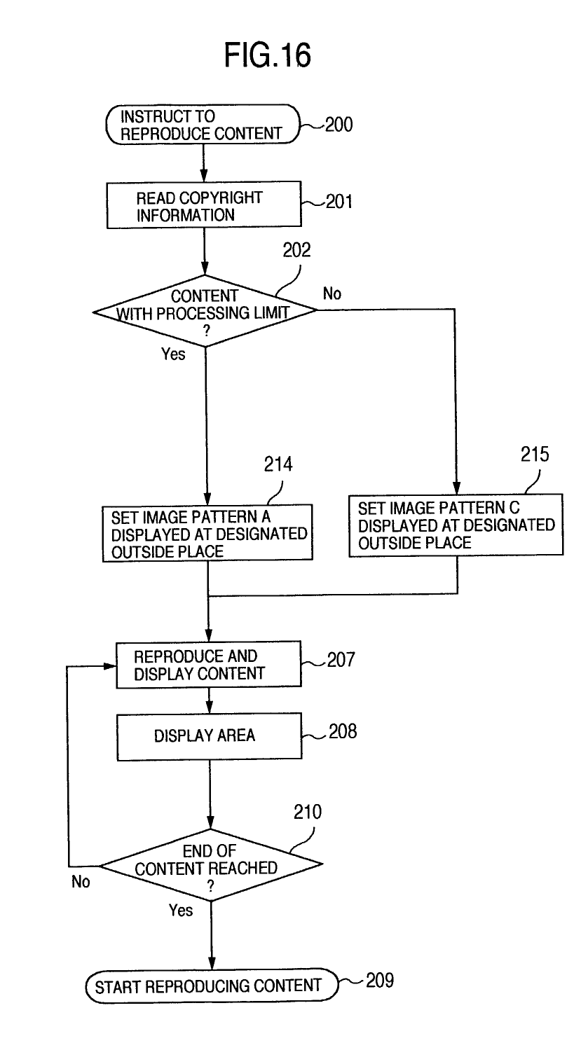

Next, a sixth embodiment of the present invention will be explained with reference to FIG. 16. FIG. 16 is a flowchart showing the process flow according to an example of the method of displaying contents at a portable communication terminal. The process starts at the contents playback instruction step (200), followed by the copyright protection information read step (201) for reading the copyright protection information limiting the processing of playback or duplication. Then, in the processing limitation determining step (202), it is determined whether the specifics of the copyright protection information indicate that the processing is limited or not. When a content is found to be free from the processing limitation as a result of determination in the processing limitation determining step (202), a display pattern C is set in a display place setting step (215) as an video to be displayed at a designated place outside the content display area. When the content is found to accompany the processing limitation as a result of determination in the processing limitation determining step (202), on the other hand, a display pattern A is set in a display place setting step (214) as an video to be displayed at a designated place outside the content display area. Then, the content is displayed in the content display step (207). Further, in the area display step (208), the pattern designated in the display place setting step (215) or the display place setting step (214) is displayed in the area outside the content display area.

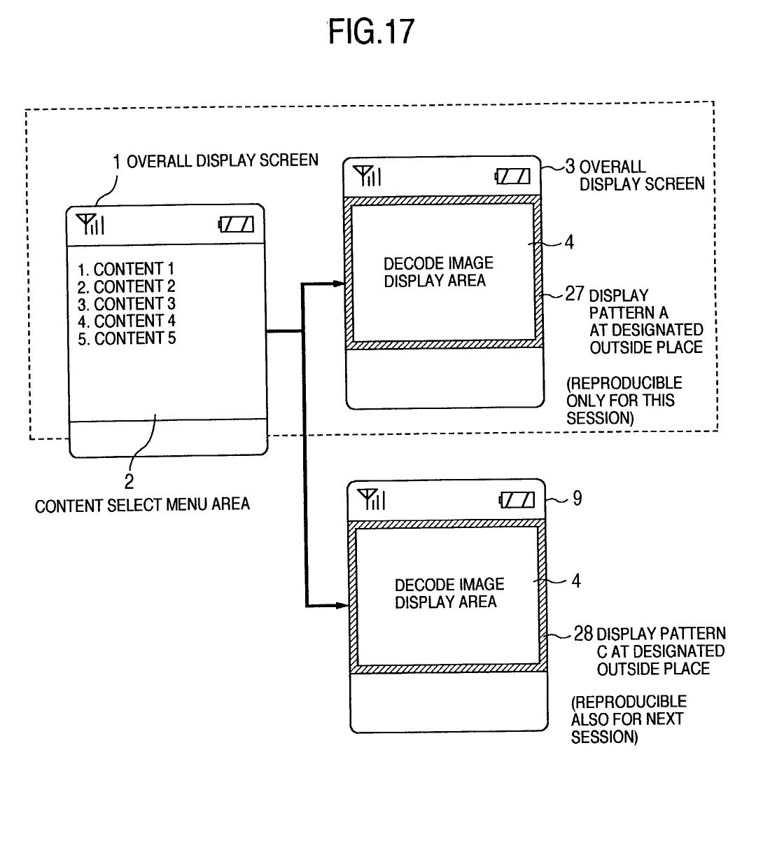

FIG. 17 shows screens displaying the results of the processing according to the embodiment of FIG. 16. The content select menu area 2 is located in the overall display screen 1, in which each content is displayed. As a result of giving an instruction to reproduce a given content, the content is reproduced and displayed with a different pattern in accordance with the specifics of the copyright protection information attached to the content. When the specifics of the copyright protection information indicate that the playback is possible only for the present session, for example, an area 27 is displayed by the pattern A as in the overall display screen 3, and the content is reproduced and displayed in the decode video display area 4. When the specifics of the copyright protection information indicate that the limitless playback is possible, on the other hand, an area 28 is displayed with the pattern C as in the overall display screen 9, and the content is reproduced and displayed in the decode video display area 4. The designated place, though located outside the content display area 27 according to this embodiment, may alternatively be inside the content display area 27 as long as the content display is substantially not affected.

By displaying the pattern difference at a designated place outside or inside the content display area as described above, the user can be sensorially informed of the copyright protection information even during the playback of the content.

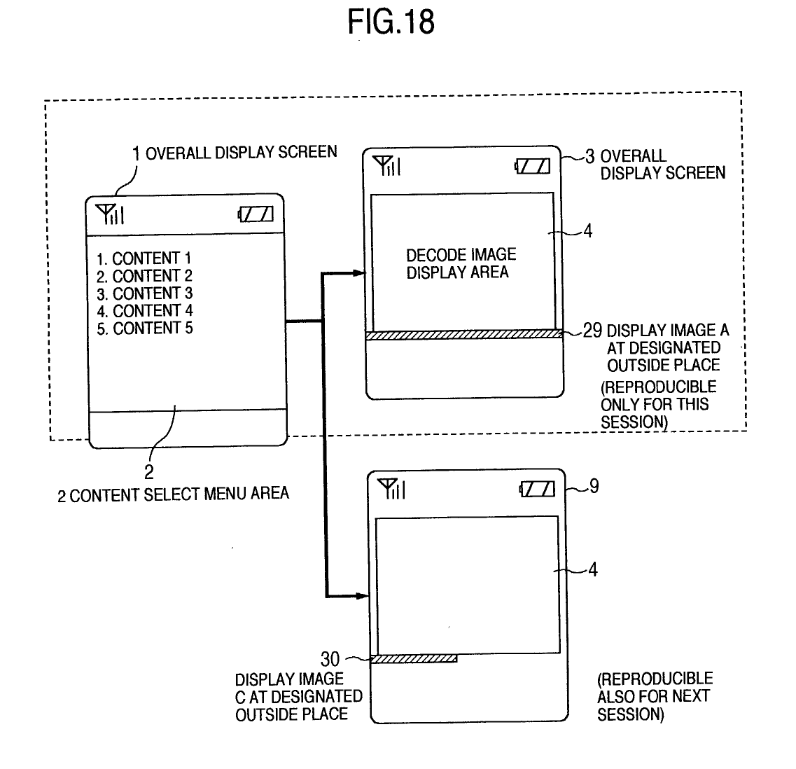

Now, a seventh embodiment of the present invention will be explained with reference to FIG. 18. FIG. 18 shows an example of carrying out the playback and display of the content while setting a different area for pattern display in accordance with the specifics of the copyright protection information attached to the content. The content select menu area 2 is located in the overall display screen 1, in which each content is displayed. As a result of giving an instruction to reproduce a given content, the content is reproduced and displayed with a different pattern in accordance with the specifics of the copyright protection information attached to the content. When the specifics of the copyright protection information indicate that the content can be reproduced only for the present session, a designated outside place 29 constituting an inner part of the overall display screen 3 is displayed with a pattern A, and the content is reproduced and displayed in the decode video display area 4. When the specifics of the copyright protection information indicate that the content can be reproduced limitlessly, on the other hand, a designated outside place 30 constituting a part of the overall display screen 9 is displayed with a pattern C, and the content is reproduced and displayed in the decode video display area 4.

This mechanism can also sensorially inform the user of the copyright protection information for the content by means of the difference in pattern display position during the playback of the content.

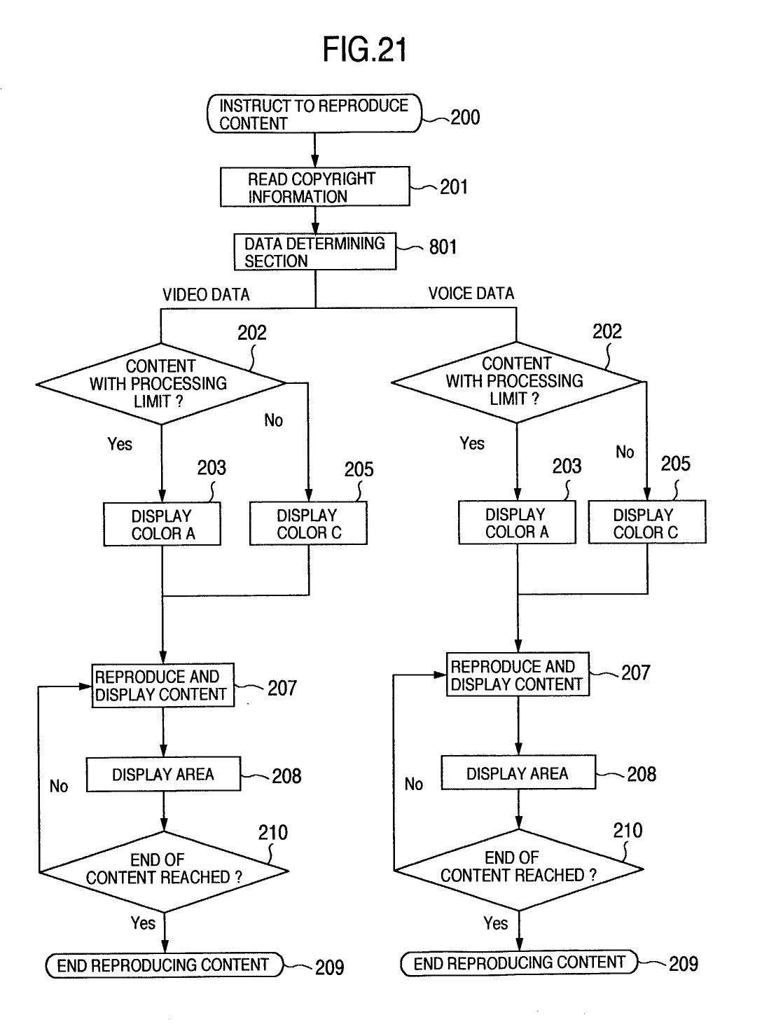

An eighth embodiment of the present invention will be explained with reference to FIG. 21. Instead of the video data used in the embodiments described above, audio data can be employed with equal effect. FIG. 21 shows a process according to this embodiment. In a data determining step (801), it is determined whether the received data is video or audio data. In FIG. 21, the component parts identical to those shown in FIG. 1 are designated by the same reference numerals and have the same functions, respectively.

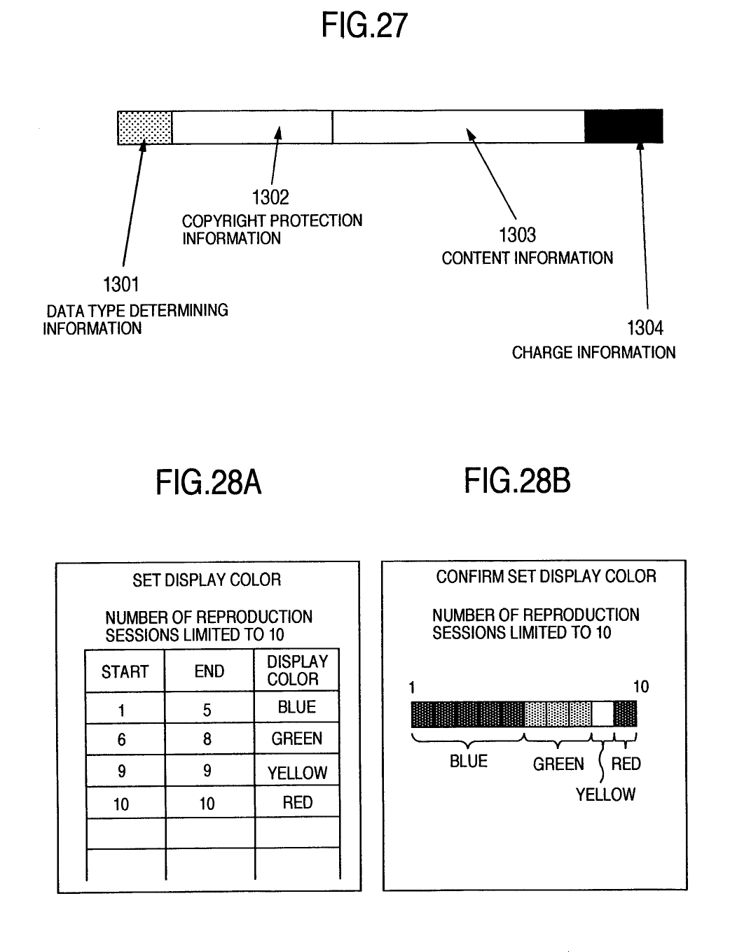

FIG. 27 shows a data structure. Reference numeral 1301 designates a data type determining information field provided for discriminating video data, audio data and other data. Numeral 1302 designates a copyright protection information field, numeral 1303 a contents information field containing video or audio data, and numeral 1304 a charge information field used for purchasing the contents or the like. The charge information includes information such as a user identification number and a content price required for purchase and sale of contents. The video data, audio data and other data are discriminated from each other by the information of the data type determining information field 1301 at the time of reading the data.

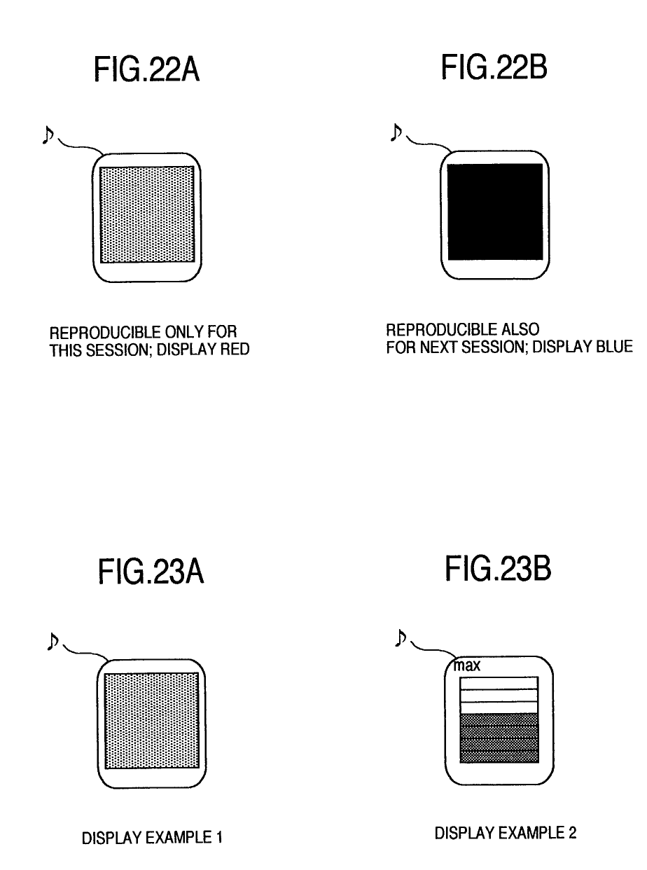

When the data is determined as audio data in the data determining step, as in the case where the data is determined as video data, a different display color is displayed and the content is reproduced in accordance with the specifics of the copyright protection information attached to the content. FIGS. 22A and 22B show examples of the display screen according to this embodiment. FIG. 22A shows an example displayed in red in the case where the content can be reproduced only for the present session, i.e. for the last playback session, and FIG. 22B an example displayed in blue in the case where the content can be reproduced also for the next session. Regardless of whether the content is video data or audio data, therefore, the copyright protection information of the content can be sensorially notified to the user during the playback of the content.

It is necessary, on the other hand, to reduce the display area of the copyright protection information in order to prevent the quality deterioration of the video data. As far as the audio data are concerned, however, the display area of the copyright protection information is not required to be reduced, and characters or audios or a combination thereof can be used as a pattern for notification. A display example for reproducing audio data is shown in FIGS. 23A and 23B. FIG. 23A shows an example displayed with a text and a color when the content can be reproduced only once more out of a total of five sessions to which the playback is limited. FIG. 23B is a histogram indicating the number of times a content has so far been reproduced and the number of sessions still available for playback, with the color changed progressively toward the number limit of sessions. As an alternative, such information as the name of an artist, the title of a musical composition or the playback time can be displayed together with the copyright information. In this way, the user can be informed of the copyright protection information by various methods, and more positively during the playback of the content.

When the content is visual data, the copyright protection information can be notified in audios in order to prevent the deterioration of the visual data. When the content is audio data, on the other hand, the notification method can be switched to a display color or text. In this way, it is possible to realize a method of indicating the copyright protection information suitable for both visual data and audio data.

The embodiments described above refer to a case in which the contents are displayed by being classified into two or three categories in accordance with the specifics of the copyright information. The present invention, however, is not limited to such a case. In accordance with the information limiting the processing such as playback or duplication of the contents, the user can freely set the number of playback or duplication sessions in steps. Assume that a given content can be reproduced ten times in total. For example, the first to fifth playback sessions are displayed in blue, the sixth to eighth playback sessions in green, the ninth playback session in yellow, and the last tenth playback session in red.

FIGS. 28A and 28B show examples of the screen in which different display colors are set freely in steps in accordance with the information limiting the processing of the content. FIG. 28A shows an example of the display in which the user inputs a display color, and FIG. 28B an example of the screen for confirming the display color thus set. Apart from the colors for display described above, the form of display or the sound can of course be similarly be used by setting it in steps freely in accordance with the information limiting the processing such as playback or duplication of the contents. As a result, the display can be changed in steps as desired by the user, thereby contributing to the operating convenience of the user.

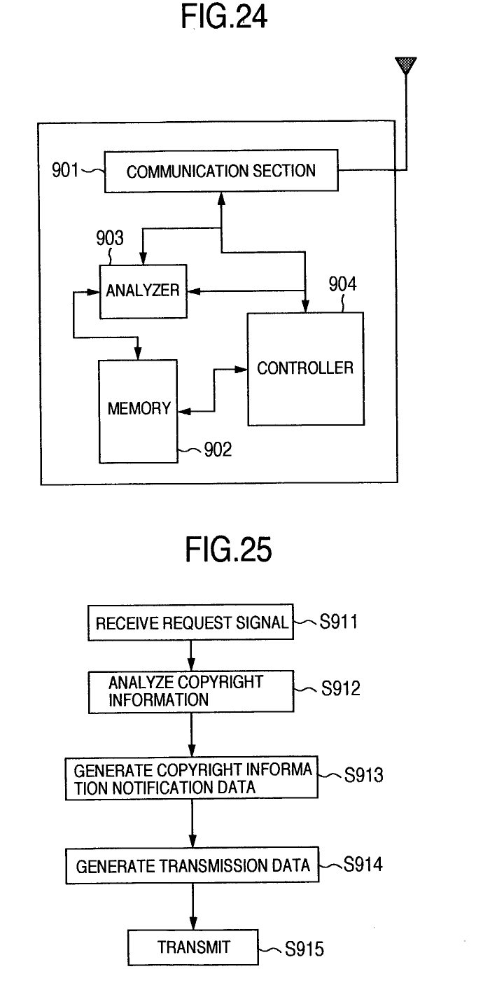

With reference to FIGS. 24 and 25, an information processing method according to a ninth embodiment of the present invention will be explained in which the communication data for notifying the copyright information is generated. FIG. 24 diagrammatically shows a configuration of an information processing system. The information processing system according to this embodiment includes a communication section 901 for communicating with an external information processing system, a memory 902 for storing data, an analyzer 903 for analyzing the copyright protection information of the received data, and a controller 904 for controlling the whole system in coordination.

FIG. 25 shows a process for performing the communication with an external information system such as a user terminal. First, the communication section 901 receives a request signal for download or the like from an external information processing system (S911). The analyzer 903 checks whether the additional information such as the copyright protection information is contained in the content received and analyzes the specifics of the copyright protection information, if any, as to the playback or duplication of the content (S912). The controller 904 generates, during the playback,of the content, a notification signal (hereinafter referred to as “the copyright information notification data”) for informing the user of the specifics of the copyright protection information analyzed by the analyzer 903 (S913), and adds it to the received data (S914). The data processed in the controller 904 are transmitted to an external information processing system (S915). Though not described above, means can of course be provided for authenticating the user by exchanging the ID information before transmitting the content.

According to this method, the copyright information notification data, whereby the copyright protection information for playback or duplication can be notified during the playback of the content, can be generated by the information processing system of the user. Thus, the requirement of the other party of the communication can be met while at the same time reducing the information processing load on the other party. Nevertheless, the copyright information notification data may not necessarily be generated as described above, but can alternatively be stored or input from outside. This reduces the processing load on the server.

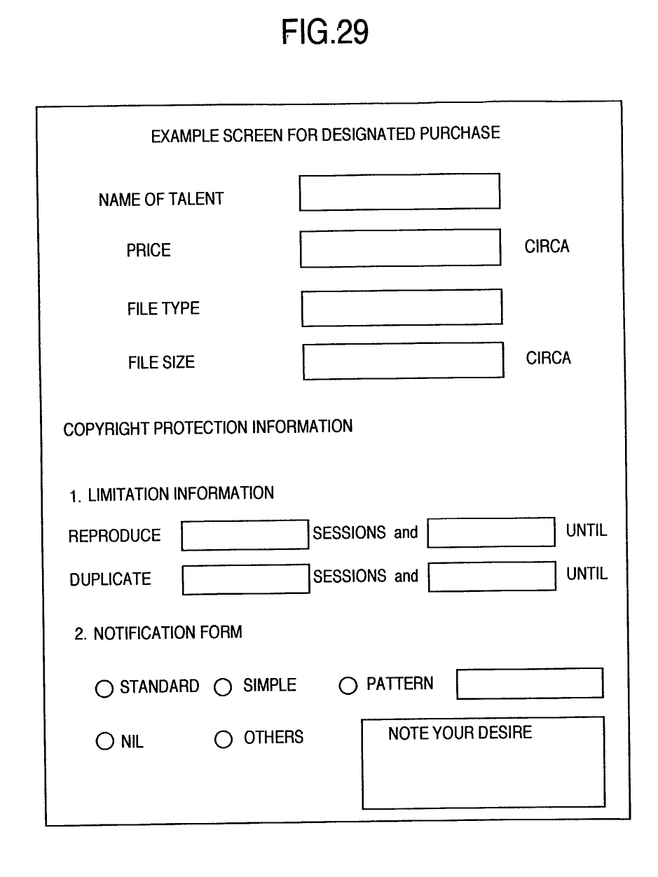

The request from the other party may of course be for the copyright information. A configuration is possible, as shown in FIG. 29, that can receive a request “WANT MUSIC DATA OF MR. &Ovalhollow;Δ [symbol] , TALENT, REPRODUCIBLE (AVAILABL FOR PLAYING BACK) TEN TIMES AT ABOUT 200 YEN”, for example. In the process, the position or form in which the copyright information notification data is displayed may be changed in keeping with the request of the other party. For example, selection is made possible from the standard pattern and several existing patterns. The request of the user may be “WANT VIDEO DATA REPRODUCIBLE FOR FIVE DAYS AT 400 YEN WITH COPYRIGHT PROTECTION INFORMATION DISPLAYED IN DIFFERENT COLOR EVERY OTHER DAY” or “WANT AUDIO NOTIFICATION OF COPYRIGHT PROTECTION INFORMATION AS VIDEO SIGNAL IS DOWNLOADED”. To meet these requests, the copyright information notification data may be selected from the patterns existing in the server or generated anew. In this way, the other party of communication can very conveniently select the copyright protection information displayed as desired while the content is being processed.

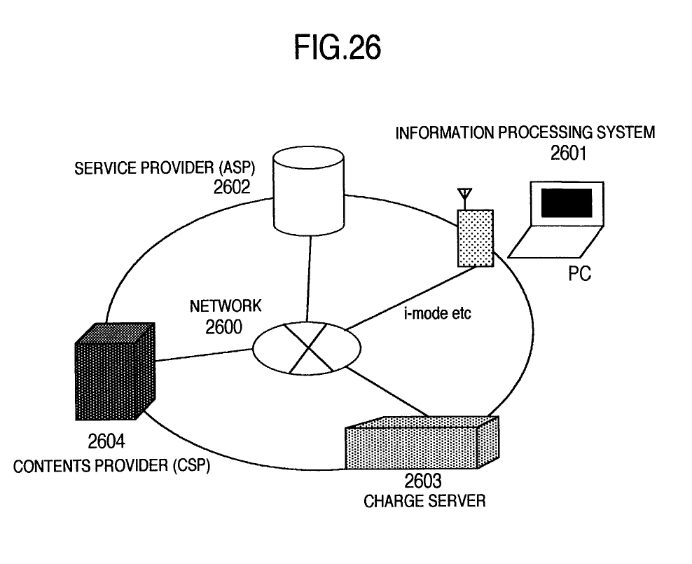

Next, an embodiment for a system utilizing this invention will be explained. FIG. 26 shows an example of an outline of the whole system. Reference numeral 2601 designates an information processing system such as a portable telephone, PC or PDC. The contents information such as an video, music or game provided from a contents provider 2604, for example, is distributed to the users in general by a service provider 2602 through a network 2600. A charge server 2603 is for charging a toll for the contents information through,the network 2600. Each user can be provided with the information through the service provider 2602 or directly from the contents provider 2604 using the information processing system 2601. The service provider 2602 or the contents provider 2604 is equipped with an information distribution server for exchanging data.

The processing in the whole system will be explained. The information processing system 2601 receives the contents with the copyright protection information distributed from the information distribution server of the service provider 2602, and processes them in the manner described above in the first to eighth embodiments. In this way, the copyright information is displayed on the contents display screen or notified by an audio signal during the playback of a content. As a result, the user can be sensorially informed of the copyright information without taking the trouble of switching the display screen while reproducing the content.

In this invention, it is sufficient if the copyright protection information can be notified in simplistic fashion while the content is being processed in the information processing system. Nevertheless, this requirement is met not necessarily on the part of the information processing system, but by providing, for example, a system in which the information processing method as described in the ninth embodiment is carried out by the service provider 2602 or the contents provider 2604 or a system in which the functions of the invention are shared between the information processing system 2601 and the providers 2602, 2604.

Further, in another alternative conceivable for carrying out an embodiment of this invention, the copyright information is displayed on the contents display screen or notified by an audio signal during the playback of a content by downloading a program to the information processing system 2601 from a home page or the like or installing the program through an external recording medium. Also in this case, the user can be notified of the copyright information sensorially while reproducing the content without taking the trouble of switching the display screen.

Examples of the contents, the video data and the audio data described above of course include a movie, music, game, TV program, commercial message, advertisement and the information picked up by a digital camera or the like.

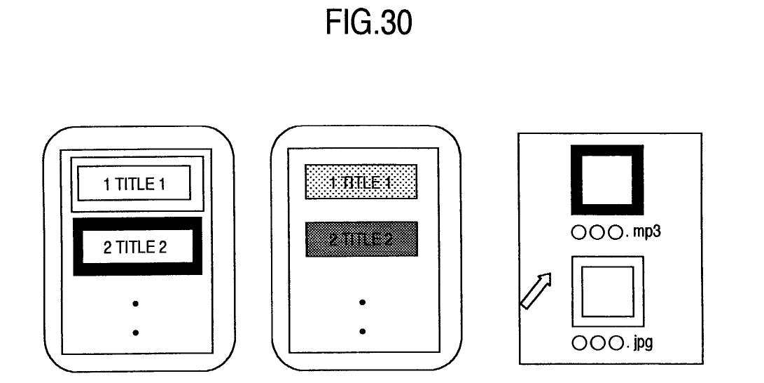

This invention is not limited to the embodiments described above. As shown in FIG. 30, for example, the information indicating the specifics of a content such as the title of a content or the icon of the content folder may contain copyright protection information displayed with color information. Also, the invention is likewise applicable of course in any other form which displays limitation information such as the number of times a content can be reproduced or duplicated.

As described above, according to this invention, the operating convenience for display is improved.

It should be further understood by those skilled in the art that although the foregoing description has been made on embodiments of the invention, the invention is not limited thereto and various changes and modifications may be made without departing from the spirit of the invention and the scope of the appended claims.

1. An information processing system comprising:
an interface which receives first information concerning at least selected one of a video and a audio and second information for restricting the processing of said first information;
a memory which stores said first and second information received by said interface; and
a processor which processes at least selected one of the video and the audio based on the first information stored in said memory, and controls a display unit to display thereon information representing a restriction for the processing of said first information based on said second information while at least selected one of the video and the audio is being processed based on said first information.

2. An information processing system comprising:
an interface which receives first information containing at least selected one of video data and audio data and second information for restricting selected one of playback and duplication of said first information;
a memory which stores said first and second information received by said interface; and
a processor which carries out selected one of playback and duplication of at least selected one of the video data and the audio data contained in the first information stored in said memory, determining whether said first information is video data or audio data, and causing a,display unit to display said second information while carrying out selected one of playback and duplication of selected one of the video data and the audio data contained in said first information;
wherein during selected one of playback and duplication of said first information, said second information is displayed differently according to whether said processor determines that said first information is video data or audio data.

3. An information processing system according to claim 1,
wherein said second information is for restricting selected one of the number of times selected one of playback and duplication of said first information is carried out on the one hand and selected one of the period during and the time at which selected one of playback and duplication of said first information is carried out on the other hand.

4. An information processing system according to claim 1,
wherein said second information is displayed in different colors in accordance with selected one of the number of times and the period during which said first information has been processed.

5. An information processing system according to claim 4,
wherein said first information is video information, and said second information is displayed at a position not in superposed relation with said video information.

6. An information processing system with a display screen, comprising:
an interface which receives the content information for a video and the control information for selected one of the number of times and the period during which selected one of playback and duplication of said content information is carried out;
a memory which stores the content information and the control information received by said interface;
a display section which displays said content information on said display screen when the requirement is met for said control information in respect of selected one of the number of times and the period during which selected one of playback and duplication of said content information is carried out; and
a counter which counts selected one of the number of times and the period during which selected one of playback and duplication of said content information has been carried out;
wherein said content information is displayed on said display screen at the same time as selected one of the remaining number of times and the remaining period during which selected one of playback and duplication of said content information can be carried out.

7. An information processing system comprising:
an interface which receives data including video information and information on the conditions attached to said video information for playback of said video information;
a memory which stores said data received by said interface; and
a playback unit which plays back a video based on said video information and said information on the playback conditions contained in said data stored in said memory;
wherein the history of playback by said playback unit is recorded in said memory, and the information on selected one of the number of times and the period during which the video recorded in said memory is played back is output during the playback of said video information.

8. An information processing method comprising the steps of:
receiving a request signal from an information processing system;
outputting content information corresponding to said request signal; and
providing together with said content information, restriction information for restricting the processing of said content information and position information for indicating the position at which said restriction information is displayed on a display screen of said information processing system for processing said content information.

9. A program for causing a controller included in an information processing system to perform:
an interface function of receiving first information on at least selected one of video data and audio data and second information for restricting the processing of said first information; and
a processor function of displaying information restricting the processing of said first information based on said second information while selected one of the video and the audio based on said first information is being processed.

10. A storage medium for storing the program as described in claim 9.

11. An information distribution system comprising an information distribution server which transmits data containing first information on at least selected one of video data and audio data and second information for restricting the processing of said first information, and an information processing system for receiving the data from said information distribution server:
wherein said information distribution server has a transmission unit for transmitting said data; and
said information processing system includes an interface which receives said data, a memory which stores said first and second information received by said interface, and a processor which processes at least selected one of the video data and the audio data based on said first,information stored in said memory and causing to display information for restricting the processing of said first information based on said second information while selected one of the video data and the audio data based on said first information is being processed.

12. An information processing system comprising:
means for receiving first information on selected one of a video and a audio and second information for restricting the processing of said first information;
means for storing said first and second information received by said receiving means; and
control means for processing at least selected one of the video and the audio based on said first information stored in said storage means;
wherein said control means causes to display the information for restricting the processing of said first information based on said second information while at least selected one of said video data and said audio data based on said first information is being processed.

13. An information processing system comprising:
means for receiving first information including at least selected one of video data and audio data and second information for restricting selected one of playback and duplication of said first information;
means for,storing said first and second information received by said receiving means; and
control means for carrying out selected one of playback and duplication of at least selected one of the video data and the audio data contained in said first information stored in said storage means, determining which of the video data and the audio data is included in the said first information, and displaying said second information when carrying out selected one of playback and duplication of at least selected one of said video data and said audio data contained in said first information;
wherein selected one of playback and duplication of said first information is carried out, while displaying said second information differently according to whether said control means determines that said first information includes video data or audio data.

14. An information processing system comprising:
means for receiving data including video information and information on conditions attached to said video information for playing back said video information;
means for storing said data received by said receiving means;
means for playing back a video based on the video information and said playback condition information contained in said data stored in said storage means;
means for recording information representing a history of playback by said playback means; and
control means for outputting, during playback of said video information, the history information recorded in said playback history recording means for defining selected one of the number of times the video information has hitherto been reproduced and the period hitherto consumed by playing back said video information.
